(19) United States
(12) Patent Application Publication
(10) Pub. No.: US 2005/0232178 A1
(43) Pub. Date: Oct. 20, 2005

(54) Satellite repeater having multi-handset capability

(75) Inventors: H. Dean Cubley, Houston, TX (US); Jesus Hector Jimenez, Houston, TX (US)

Correspondence Address: CONLEY ROSE, P.C., P. O. BOX 3267, HOUSTON, TX, 77253-3267, US

(73) Assignee: Eagle Broadband, Inc., League City, TX (US)

(21) Appl. No.: 10/803,314

(22) Filed: Mar. 18, 2004

(51) Int. Cl. H04J 1/10

(52) U.S. Cl. 370/315

(57) ABSTRACT

A satellite phone repeater comprises a plurality of antennas and a plurality of amplifiers coupled to the antennas. At least one of the antennas is configured to communicate with a plurality of handsets. Through the repeater, the handsets simultaneously can communicate with a satellite. The repeater may include phase shifters to ameliorate multipath interference. The repeater may also include an electronically controlled switch that couples each of two receiver/transmitters to a single antenna configured to communicate with the satellite.

### CROSS-REFERENCE TO RELATED APPLICATIONS

This application contains subject matter that may be related to subject matter disclosed in U.S. application Ser. No. 10/225,752 entitled “Repeater for a Satellite Phone”, and filed Aug. 22, 2002, incorporated herein by reference.

### BACKGROUND

1. Field of the Invention

The present disclosure generally relates to a repeater that permits communications between a plurality of handsets at the repeater location and an orbiting satellite constellation without the handsets having a direct line of sight to the orbiting satellite.

2. Background Information

Relatively recently, satellite phones (also referred to herein as “handsets”) have been introduced into the market. A satellite phone communicates directly with an orbiting satellite thereby permitting the user of the phone to make or receive a phone call from virtually anywhere on earth. A significant limitation is that there must be an unobstructed, direct line-of-sight between the orbiting satellite and the satellite phone. Thus, such phones are generally unusable inside buildings, houses, caves, airplanes or, in general, anywhere that the phone does not have direct line-of-sight to the satellite. A solution to this problem is highly desirable and would make satellite phone technology much more usable particularly when multiple closely located satellite subscribers desire to use satellite phones inside building, airplanes, and other closed structures.

### BRIEF SUMMARY

In accordance with at least some embodiments of the invention, a satellite phone repeater comprises a plurality of antennas and a plurality of amplifiers coupled to the antennas. At least one of the antennas is configured to communicate with a plurality of handsets. Through the repeater, the handsets can communicate with a satellite. The repeater may include phase shifters to ameliorate multipath interference. The repeater may also include an electronically controlled switch that couples each of two receiver/transmitters to a single antenna configured to communicate with the satellite.

### BRIEF DESCRIPTION OF THE DRAWINGS

For a detailed description of the preferred embodiments of the invention, reference will now be made to the accompanying drawings in which:

FIG. 1 shows a system level diagram of a repeater providing a wireless interface between a plurality of satellite handsets and an orbiting satellite; and

FIG. 2 shows an embodiment of the repeater in which phase shifters are included to reduce multipath interference;

FIG. 3 shows an embodiment of the repeater in which a switch is included to permit only a single antenna to be used to communicate with the orbiting satellite;

FIG. 4 shows an embodiment of the repeater in which both the phase shifters of FIG. 2 and the switch of FIG. 3 are included; and

FIG. 5 illustrates the operation of the phase shifters of FIGS. 2 and 4.

### NOTATION AND NOMENCLATURE

Certain terms are used throughout the following description and claims to refer to particular system components. As one skilled in the art will appreciate, different companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION OF THE PREFERRED EMBODIMENTS

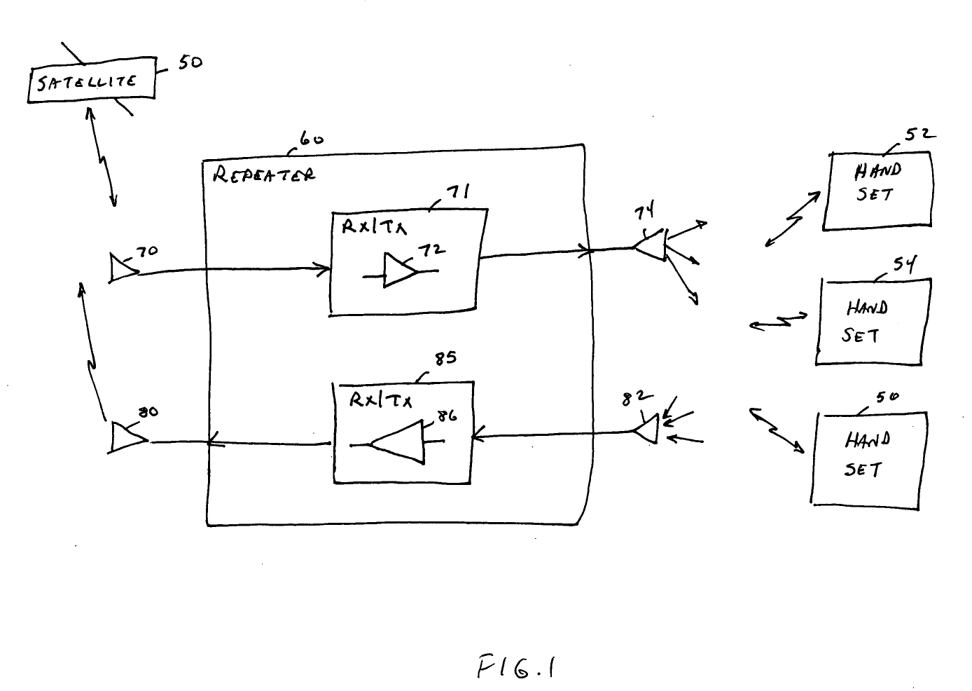

Referring now to FIG. 1, in accordance with a preferred embodiment of the invention, a repeater 60 is provided to permit a plurality of satellite handsets 52, 54, 56 to communicate with an orbiting satellite 50. The repeater 60 may be located on or within a structure that may prevent effective (i.e., line of sight) communications between the handsets 52-56 and the satellite 50. The handsets may comprise, for example, 9505 Mobile Phones manufactured by Motorola. The structure may be a building, a natural formation such as a cave, the fuselage of an aircraft or spacecraft, or in general any material or object that precludes an effective line-of-sight communication link between satellite 50 and handsets 52-56.

In at least some embodiments, the repeater 60 is configured to provide communications with the Iridium satellite constellation, although other satellite systems now known or later implemented can be used as well. As such, the handsets preferably are Iridium-compatible satellite phones, such as the 9505 Mobile Phone, or comparable phone, noted above. The frequency range usable for Iridium-based satellite phone communications is the L-band (i.e., 1616-1626.5 MHz). Accordingly, the repeater 60 is configured to accommodate communications in this frequency range.

The repeater 60 preferably enables two-way communications between the handsets 52-56 and the satellite 50. The repeater includes a pair of antennas 70, 80 for communication with the satellite 50. The repeater also includes a pair of antennas 74, 82 for communication with the handsets 52-56. The repeater further includes a pair of receiver/transmitter (“RX/TX”) (i.e., a bidirectional amplifier). Each RX/TX unit includes an amplifier. RX/TX unit 71 includes an amplifier 71 and RX/TX unit 85 includes an amplifier 86. The amplifiers 72 and 86 amplify an incoming signal from an antenna. Other circuitry may be included in each RX/TX unit. The RX/TX unit 71 couples to antennas 70 and 74 and amplifies downlink signals received via antenna 70 from the satellite 50 to be provided to the handsets via antenna 74. The RX/TX unit 85 couples to antennas 80 and 82 and amplifies uplink signals received via antenna 82 from the handsets to be provided to the satellite 50 via antenna 80. As such, separate and opposing communication paths are enabled by the four antennas and two RX/TX units thereby enabling two-way communications between the handsets and the satellite.

As explained above, the repeater 60 functions to transmit incoming signals from the satellite 50 to the handsets 52-56, as well as transmit signals from the handsets to the satellite. As such, the repeater 60 provides a communication pipeline between the satellite and phone. As noted above, the repeater preferably is located inside or on a structure (e.g., building, aircraft, etc.). Antennas 70 and 80 preferably are positioned so as to provide a direct line-of-sight to the satellite 50. Antennas 70 and 80 may be mounted, or otherwise formed, on an exterior surface of the repeater 60. Alternatively, the antennas 70, 80 may be mounted apart from the repeater and connected to the repeater's electronics via a suitable low-loss radio frequency (“RF”) coaxial cable in accordance with known techniques. To reduce the detrimental effects of crosstalk and increase physical isolation, the antennas 70 and 80 may be spaced from each other by a predetermined distance (e.g., 60 feet). Antennas 74 and 82 need not be positioned to provide line of sight to the satellite, but rather to provide interior satellite broadcast capabilities to the handsets 52, 54, and 56.

Antenna 70 may be any suitable antenna such as the S67-1575-109 exterior aircraft antenna manufactured by Sensor Systems. This particular antenna has a frequency response of 1616-1626.5 MHz and a return loss of −9.5 dB. Antenna 74 may also be the S67-1575-109 exterior aircraft antenna manufactured by Sensor Systems having a frequency response of 1616-1626.5 MHz and a return loss of −9.5 dB. Antennas 80 and 82 may the same types of antennas as are used to implement antennas 70 and 74.

Amplifier 72 preferably is any suitable low-noise amplifier usable as described herein. One suitable embodiment of amplifier 72 is the Iridium low noise amplifier (LNA) which has a frequency response of 1600-1650 MHz, a gain of +76 dB, a P1 dB of +10 dBm, an input voltage of +15.0 VDC and a maximum current rating of 190 mA. Amplifier 86 preferably comprises a pair of preamp stage and a power amplifier. The two preamp stages may be the same, or different. In one embodiment, the preamp stages comprise Iridium XMIT Preamps which have a frequency response of 1600-1650 MHz, a return loss of 2.0:1, a gain of +38 dB, a P1 dB of +10 dBm, an input voltage of +15 VDC, and a maximum current of 150 mA. The power amplifier preferably comprises an Iridium XMIT Power Amplifier which has a frequency response of 1600-1650 MHz, a return loss of 2.0:1, a gain of +36 dB, a P1 dB of +38 dBm, an input voltage of +15 VDC, and a maximum current of 3500 mA. In other embodiments, the preamp stages could be combined together into a single preamp stage. Further, all three stages of amplifier 86 could be combined together into a single amplifier device.

The power level of the transmissions to the satellite may need to be within a predetermined range. For example, the Iridium communication system requires transmissions to the satellite 50 to be between 0.6 W and 5 W per communication channel. Too much transmission power may result in distortion of the signals as required by the satellite. In some embodiments, the gain of amplifiers 72 and 86 may be predetermined and fixed (i.e., non-adjustable in use) so as to implement the required transmission power. Fixing the gain of amplifiers 72 and 86 may impose a location restriction on the use of the handsets 52-56. That is, for given amplifier gain settings, the handsets 52-56 may be required to be within a predetermined distance range of the repeater's antennas 74 and 82. Attempting to operate a handset too close to the repeater 60 may result in excessive transmission power to the satellite, while attempting to operate a handset too from the repeater far may result in an excessively low signal level received by the satellite. The predetermined distance range is effected by geometry of the structure in which the repeater 60 and handsets are used as well as the amount and type of material in the vicinity of the handsets and the repeater (e.g., furniture, walls, metallic reflective surfaces, etc.).

In some applications of the repeater 60, multipath interference may detrimentally effect communications between the repeater 60 and the various handsets. Multipath interference results from a signal transmitted, for example, by a handset being propagated to the receiver's antenna 82 over a plurality of pathways. One pathway may include a direct transmission from the handset to the receiver antenna while other pathways may include reflected signals off the structure containing the repeater and objects (e.g., furniture) therein. Multipath interference may detrimentally effect transmissions between the repeater 60 and the handsets in either direction (i.e., receiver to handset and handset to receiver). One effect of multipath interference is the creation of “null” locations in which reflected signals cancel or largely cancel directly transmitted signals.

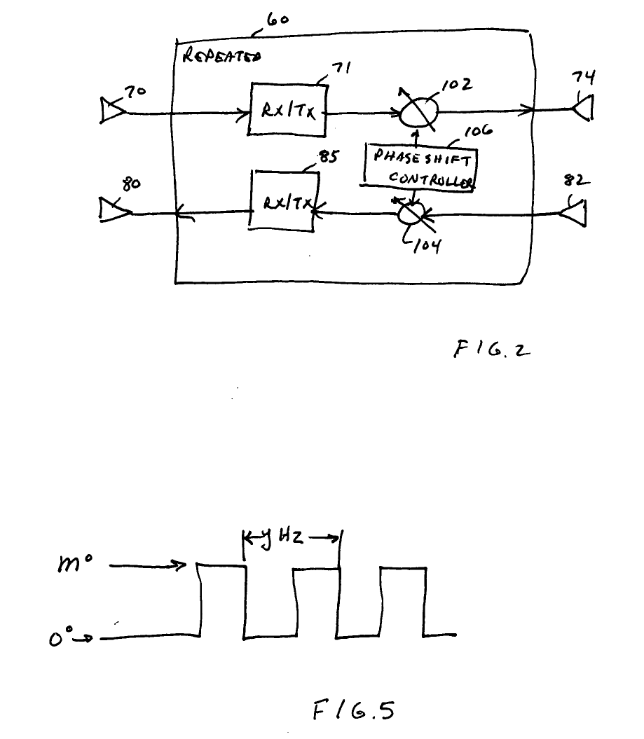

In an alternative embodiment of the invention shown in FIG. 2, the repeater 60 includes one or more phase shifters 102 and 104. The phase shifters 102 and 104 may comprise known off-the-shelf components. Each phase shifter couples to a corresponding RX/TX unit 71 or 85 and an antenna 74 or 82. Each phase shifter is capable of shifting the phase of the corresponding signal by a controllable amount. The amount of phase shift is therefore controlled by phase shift controller 106. In accordance with a preferred embodiment of the invention, the phase shift controller 106 varies the phase of the uplink signal being provided by the handsets to the satellite between 0 degrees and m degrees according to a rate of y Hertz (“Hz”). In some embodiments, m is between about 90 degrees and 180 degrees and y is between about 1 Hz and 25 Hz and preferably is about 10 Hz. These relationships are illustrated in FIG. 5. The frequency with which the phase is varied is preferably faster than the response time of the corresponding RX/TX units 71, 85, yet slow enough so as not to effect the modulation of the encoded signal. By varying the phase shift, the signals at the null locations become higher than would be the case without the phase shifters.

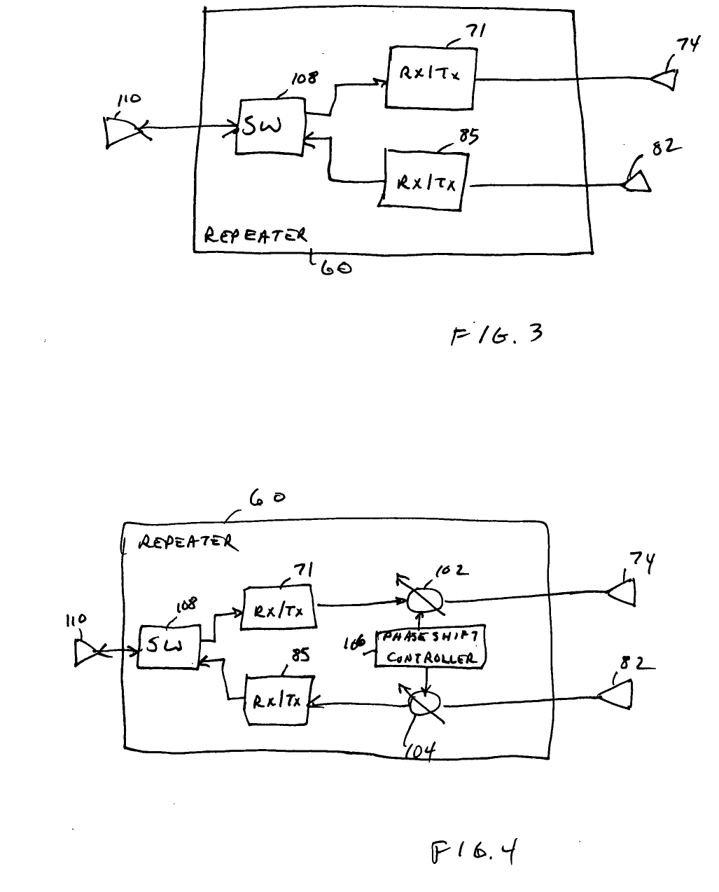

FIG. 3 illustrates an alternative embodiment in which the repeater 60 includes an electronically controlled switch 108. The switch 108 selectively couples the antenna 110 to one of the RX/TX units 71 and 85 depending on whether an uplink signal or a downlink signal is being transmitted. In this embodiment, preferably only a single antenna 110 is used by the repeater to communicate with the satellite, rather than multiple antennas as in the embodiments of FIGS. 1 and 2. When the satellite transmits a downlink signal to the handsets, the switch 108 routes the downlink signal to the RX/TX unit 71. Similarly, when one or more handsets 52-56 transmit an uplink signal to the satellite, the switch 108 routes the uplink signal from the RX/TX unit 85. The switch 108 preferably operates fast enough that the user of a handset cannot tell that the switching is occurring. The embodiment of FIG. 3 is generally suitable for any application, but particularly suitable for applications which benefit from having only one antenna to the satellite. For example, an airplane application in which the receiver 60 permits passengers and crew inside the fuselage to use their satellite phone handsets, having only a single antenna to communicate with the satellite advantageously reduces the number of hull penetrations.

The switch 108 is controlled based on a control signal in the uplink and downlink data stream. The control signal preferably indicates the direction of data flow (satellite to handset or handset to satellite). The implementation of the control signal depends on the particular satellite system being used and thus may vary from application to application.

FIG. 4 illustrates an alternative embodiment of the repeater 60 in which both the phase shifters 102, 104 and the switch 108 are included. The repeater of FIG. 4 is thus able to ameliorate the effects of multipath interference and to reduce the number of antennas needed to communicate with the satellite.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A satellite phone repeater, comprising:
a plurality of antennas; and
a plurality of receiver/transmitters coupled to the antennas;
wherein at least one of the antennas is configured to communicate with a plurality of handsets simultaneously and, through the repeater, the handsets can communicate with an orbiting satellite.

2. The satellite phone repeater of claim 1 wherein one antenna permits communications to be transmitted to the handsets and another antenna permits communications to be received from the handsets.

3. The satellite phone repeater of claim 1 further comprising a phase shifter coupled to at least one antenna.

4. The satellite phone repeater of claim 3 further comprising a phase shift controller coupled to the phase shifter, said phase shift controller configured to cause the phase shifter to vary phase of a signal to or from an antenna at a rate that is faster than a response time of a receiver/transmitter yet slow enough so as not to change modulation of the signal.

5. The satellite phone repeater of claim 1 further comprising a switch coupled to at least two receiver/transmitters, said switch selectively coupling each of the two receiver/transmitters to a satellite antenna, said satellite antenna being the only antenna used by the two receiver/transmitters to communicate with the satellite.

6. An electronics device, comprising:
means for communicating via a direct line of sight link to an orbiting satellite;
means for simultaneously communicating with a plurality of satellite phones;
means for amplifying signals received from said satellite that target said satellite phones; and
means for amplifying signals received from said satellite phones that target said satellite.

7. The electronics device of claim 6 further comprising means varying phase of at least one of the signals.

8. A method, comprising:
receiving signals from a plurality of handsets;
amplifying said signals to produce first amplified signals; and
transmitting said first amplified signals to an orbiting satellite.

9. The method of claim 8 further comprising varying phase of the signals received from the plurality of handsets.

10. The method of claim 8 further comprising:
receiving signals from an orbiting satellite;
amplifying said signals received from the satellite to produce second amplified signals; and
transmitting said second amplified signals to one or more handsets.

11. The method of claim 10 further comprising varying phase of the signals received from the satellite.

12. The method of claim 10 further comprising selectively coupling each of two communication paths to a single antenna adapted to communicate with the satellite.

13. A repeater, comprising:
a first antenna configured to receive first signals from a plurality of satellite communication handsets;
a second antenna configured to transmit second signals to said handsets;
a third antenna configured to communicate with a satellite;
a first receiver/transmitter coupled to the first antenna;
a second receiver/transmitter coupled to the second antenna;
wherein at least one of the antennas is configured to communicate with a plurality of handsets and, through the repeater, the handsets can communicate with a satellite.

14. The repeater of claim 13 further comprising an electronic switch coupled to the third antenna and the first and second receiver/transmitters, said switch sequentially couples each of the first and second receiver/transmitters to the third antenna so that the repeater includes only a single antenna to communicate with the satellite.

15. The repeater of claim 14 further comprising a first phase shifter coupled to the first receiver/transmitter and the first antenna and a second phase shifter coupled to the second receiver/transmitter and the second antenna, said first and second phase shifters configured to vary the phase of signals passing to the first antenna and received from the second antenna.

16. The repeater of claim 15 further comprising a phase shift controller coupled to the first and second phase shifters, said phase shift controller configured to cause the phase shifters to vary the phase at a frequency of y Hz and between a phase shift of about 0 degrees and about m degrees, wherein y is between about 1 Hz and about 25 Hz and m is between about 90 degrees and about 180 degrees.

17. The repeater of claim 13 further comprising a first phase shifter coupled to the first receiver/transmitter and the first antenna and a second phase shifter coupled to the second receiver/transmitter and the second antenna, said first and second phase shifters configured to vary the phase of signals passing to the first antenna and received from the second antenna.
